(19) United States
(12) Patent Application Publication
(10) Pub. No.: US 2015/0224519 A1
(43) Pub. Date: Aug. 13, 2015

(54) Spray Head with Valve

(71) Applicant: Hansgrohe SE, Schiltach (DE)

(72) Inventors: Jürgen Bühler, Schiltach (DE); Stephanie Laun, Schramberg-Tennenbronn (DE)

(21) Appl. No.: 14/618,403

(22) Filed: Feb. 10, 2015

(30) Foreign Application Priority Data
Feb. 11, 2014 (DE) 10 2014 202 474.9

(51) Int. Cl. B05B 1/18; B05B 1/16

(52) U.S. Cl. CPC B05B 1/185; B05B 1/1636

(57) ABSTRACT

A spray head with a valve includes a spray head housing, a valve within the spray head housing and an actuating element. The actuating element is axially movable along a valve longitudinal axis. A valve operating element is operable by a user and is arranged on the spray head housing. The valve operating element is rotatable around and/or axially movable along a operating element longitudinal axis. A transmission transmits rotary and/or axial movement of the valve operating element into axial movement of the actuating element. The valve operating element can be arranged with the operating element longitudinal axis non-parallel to or in parallel offset to the valve longitudinal axis. The head is useful in a shower bath, for example.

The invention relates to a spray head having a spray head housing, having a valve which is arranged in the spray head housing and has an actuating element, wherein the actuating element can be moved axially along a longitudinal valve axis, having a valve operating element which can be operated by a user and is arranged on the spray head housing such that it can be rotated about, and/or is axially movable along, a longitudinal operating element axis, and having a transmission means which transforms a rotary and/or axial movement of the valve operating element into an axial movement of the actuating element.

The spray head may be, for example, a shower spray head, by means of which a plurality of different jet-exit patterns or jet-exit characteristics of a shower jet can be realized. The valve here serves for switching over between different jet-exit characteristics and/or for switching off the shower jet within the shower spray head. DE 10 2009 008 194 B4 discloses such a switching valve, which may be provided within a hand-held spray, wherein the valve is switched by pressure being exerted on a pushbutton, which is a constituent part of the valve and is arranged at an upper end of a valve housing. An inner side of the pushbutton has arranged on it an axially moveable stem, which actuates an advancing device of the valve.

The technical problem of the invention is to provide a spray head of the type mentioned in the introduction which is easy to use, as far as valve actuation is concerned, and allows a high level of design flexibility.

The invention solves this problem by providing a spray head having the features of claim 1. In the case of the spray head according to the invention, the valve operating element is arranged with the longitudinal operating element axis non-parallel to, or in parallel offset to, the longitudinal valve axis, i.e. not in direct axial extension of the valve actuating element. It is possible here for the transmission means to be, for example, part of the actuating element and/or of the valve operating element. Since the valve operating element, which can be operated by the user, is not arranged on the spray head housing in direct axial extension of the actuating element of the valve, there is a high level of freedom or flexibility in respect of the installation position of the valve and, independently thereof, in respect of the installation position of the valve operating element and thus in respect of the valve actuation by the user.

The spray head according to the invention makes it possible, in particular, for the valve, e.g. a sanitary switchover and/or shut-off valve, to be arranged, in a manner appropriate for its shape and function and coordinated with other constituent parts of the spray head, e.g. with a water inlet or a jet disc unit, in a desired optimum position within the spray head housing. Irrespective of this, the valve operating element, e.g. a pushbutton or a rotary adjuster, may be arranged on the spray head housing at a position which is easy to reach for the user. Furthermore, this realizes a space-saving arrangement of the constituent parts of the spray head within the spray head housing and, in addition, there is freedom in respect of the design of the shape of the spray head housing.

In a development of the invention, the longitudinal valve axis is arranged non-parallel to a longitudinal jet disc axis of a jet disc unit arranged on the front of the spray head housing. In particular it may be advantageous if the longitudinal valve axis is arranged perpendicularly to the longitudinal jet disc axis. This can be utilized in order to align the longitudinal valve axis for example with a peripheral side, which is different from the front side of the spray head housing and on which the valve operating element may then be arranged.

In a development of the invention, the transmission means contains a slanted surface coupling, which transforms the rotary movement of the valve operating element about the longitudinal operating element axis into the axial movement of the actuating element along the longitudinal valve axis. For this purpose, it is advantageously possible for a slanted surface element of the slanted surface coupling to be arranged in an axially and rotationally fixed manner in relation to the valve operating element at an end of the latter which is directed towards the actuating element. In addition, or as an alternative, it is possible for a further slanted surface element of the slanted surface coupling to be arranged in an axially and rotationally fixed manner in relation to the actuating element at an end of the latter which is directed toward the valve operating element, wherein the actuating element may advantageously be arranged in a rotationally fixed manner in relation to the spray head housing.

In a development of the invention, the transmission means contains a transmission arm which is retained in a fixed or rotatable manner at a fixed end and is coupled to the valve operating element at a first coupling point, which is spaced apart from the fixed end, and is coupled to the actuating element at a second coupling point, which is spaced apart from the fixed end. In particular it is advantageous if the transmission arm, at the second coupling point, runs perpendicularly, or at least virtually perpendicularly, to the longitudinal valve axis. The transmission arm used may be, for example, a leaf spring which is clamped in at one end or a rotatably mounted rigid strip.

In one configuration of the invention, the second coupling point is arranged between the first coupling point and the fixed end of the transmission arm. This means that the transmission arm reduces a force which has to be applied to the valve operating element in order to actuate the valve.

In one configuration of the invention, the fixed end of the transmission arm is retained on a rear side of the jet disc unit, which is configured appropriately for this purpose. The rear side of the jet disc is directed towards an inner side of the spray head housing. It is possible here for example for that end of a flexible transmission arm which is to be fixed to be pushed advantageously in a straightforward manner, during installation of the jet disc unit, into an accommodating slot on the rear side of the jet disc, or that end of a rigid transmission arm which is to be fixed is installed in a rotatable manner on a bearing on the rear side of the jet disc.

In one configuration of the invention, the transmission arm has a first sleeve by means of which it is coupled to the valve operating element. In addition, or as an alternative, it has a second sleeve by means of which it is coupled to the actuating element. For example, the first sleeve engages around that end of the valve operating element which is directed towards the actuating element. It is thus possible to suppress, for example, slipping of the valve-operating-element end on the transmission arm and to achieve very fail-safe coupling between the transmission arm and the valve-operating-element end.

In one configuration of the invention, the slanted surface coupling is accommodated in the first sleeve, by means of which the transmission arm is coupled to the valve operating element. For this purpose, it is advantageously possible for the valve operating element and/or the sleeve each to have a slanted surface element.

In a development of the invention, the valve operating element can be moved between an initial position, in which a valve closure body rests against a valve seat, and an operating position, wherein the valve operating element returns automatically from the operating position into the initial position or the operating position is implemented as a sustained operating position, in which the valve closure body has been raised up from the valve seat. For example it is possible for a valve operating element defined in the form of a pushbutton to return into its initial position. As an alternative to this, it is possible, for example, for a valve operating element designed in the form of a rotary adjuster to remain in the sustained operating position, wherein a large throughflow of fluid through all of the exit openings of a jet disc unit of the spray head can be achieved when the valve closure body, in this operating position, has been raised up from the valve seat.

In a development of the invention, the valve operating element is a rotary adjuster which is arranged on a peripheral side of the spray head housing and protrudes from the spray head housing. The peripheral side is different from a front side, which is defined, for example, by a jet disc unit. Such a rotary adjuster can be easily gripped, and operated, by the user, even if his hand is soapy.

Advantageous embodiments of the invention will be described hereinbelow and are illustrated in the drawings, in which:

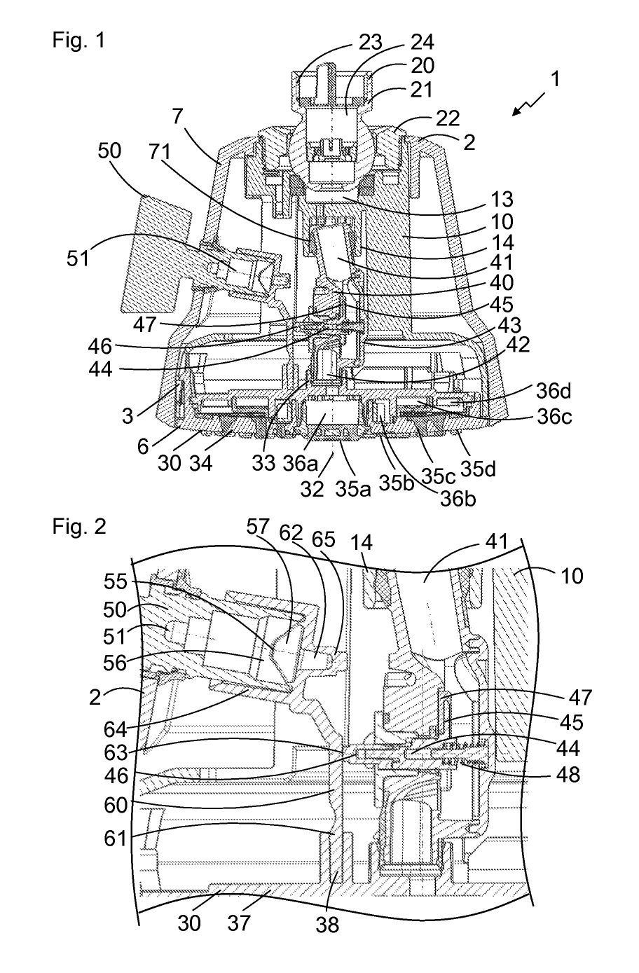

FIG. 1 shows a longitudinal-section view of a spray head,

FIG. 2 shows a detail-specific view from FIG. 1,

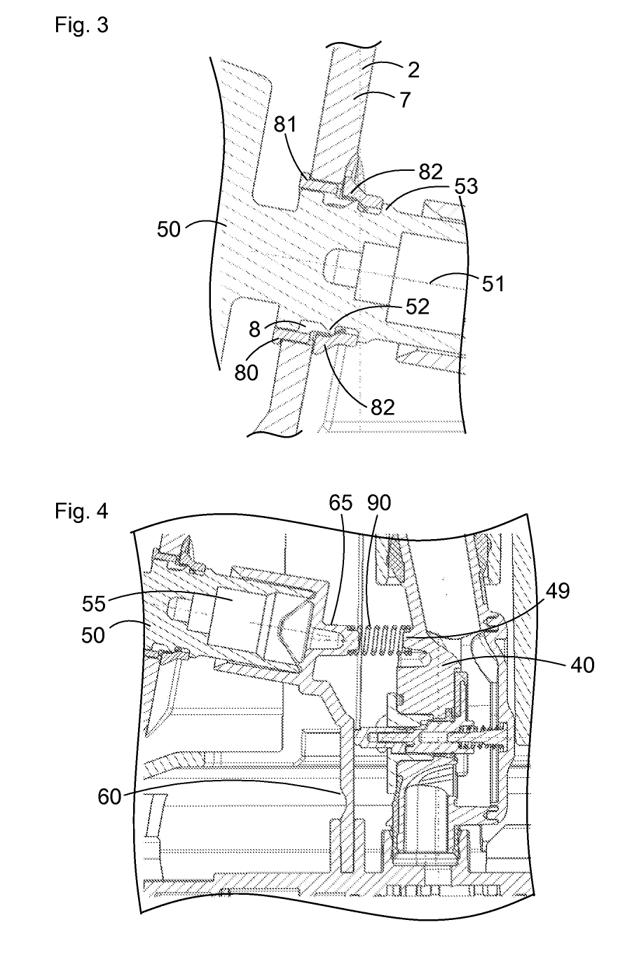

FIG. 3 shows a further detail-specific view from FIG. 1,

FIG. 4 shows a detail-specific view corresponding to FIG. 2, this time relating to a variant with an additional storing spring,

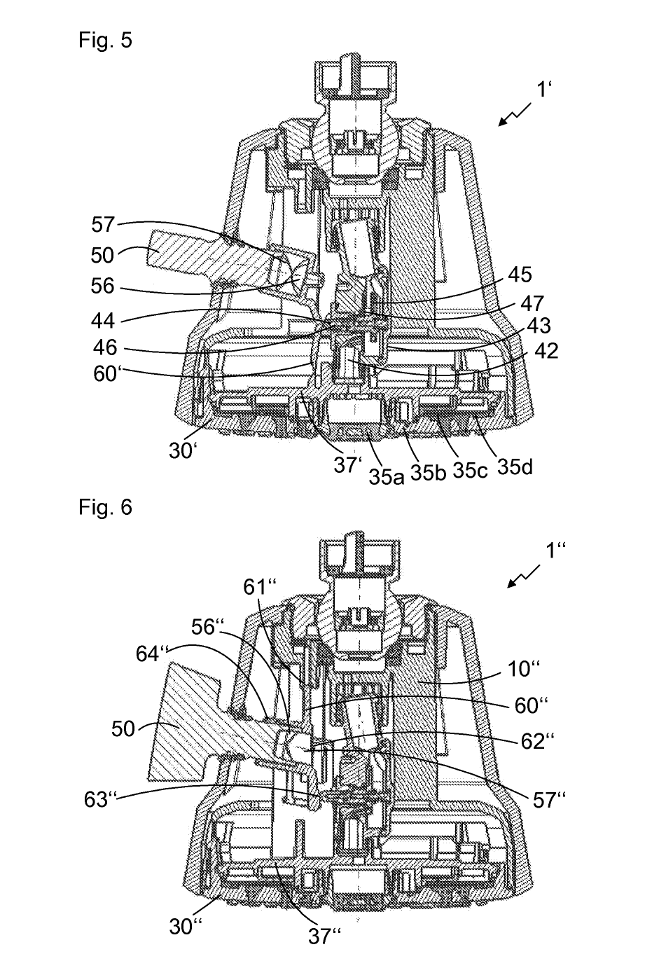

FIG. 5 shows a longitudinal-section view corresponding to FIG. 1, this time relating to alternative embodiment of a spray head, and

FIG. 6 shows a longitudinal-section view corresponding to FIG. 1, this time relating to a further alternative embodiment of a spray head.

A spray head 1, which is shown in FIGS. 1 to 4, is suitable, for example, as a shower spray head and comprises a bell-form spray head housing 2, a basic spray head body 10, a suspended connection 20, for installing the spray head 1, for example, on a fluid-supply connection (not shown here), a jet disc unit 30, a switchover and shut-off valve 40 and a valve operating element 50.

The spray head housing 2 is positioned on the basic spray head body 10 from above in FIG. 1. The jet disc unit 30 is inserted into the spray head housing 2, and into the basic spray head body 10, from beneath and is fastened on the spray head housing 2 by means of a snap-fit connection 3 and retains the basic spray head body 10 in the spray head housing 2.

The suspended connection 20 is screwed into the basic spray head body 10 from above by way of a base ring 22. The spray head 1 can be coupled to a fluid-supply connection (not shown here) by means of an internal thread 23. In order for a user to be able to orient the spray head 1, the suspended connection 20 has a ball-and-socket joint with a ball head 21, which is mounted in the base ring 22. The ball head 21 has formed within it a throughflow channel 24, which opens out into a fluid channel 13 of the basic spray head body 10.

Beneath the fluid channel 13, the switchover and shut-off valve 40 is arranged between the basic spray head body 10 and the jet disc unit 30. On the inlet side, the valve is fixed in a valve-inlet holder 14 of the basic spray head body 10 by way of a fluid-inlet nozzle 41, into which the fluid channel 13 opens out. On the outlet side, the valve is provided with a plurality of separate fluid-outlet channels 42 with associated outlet nozzles, which are fixed in corresponding valve-outlet holders 33 on a rear side 37 of the jet disc unit 30, wherein FIG. 1 shows just one of the fluid-outlet channels 42 and the corresponding valve-outlet holder 33. The valve 40, in addition, has a rear side 43 resting against the basic spray head body 10.

The switchover and shut-off valve 40, moreover, is of a design which is known per se, having a disc-like valve closure body 45, which can be moved axially along, and rotated about, a longitudinal valve axis 44, and having an actuating element 46 in the form of an actuating pin, which can be moved axially along the longitudinal valve axis 44. The valve 40 here is arranged in the spray head housing 2 such that the longitudinal valve axis 44 is located perpendicularly to a longitudinal centre axis 32 of the jet disc unit 30 and of the spray head housing 2. The valve closure body 45 rests against a planar valve seat 47 and has discrete stable rotary positions, between which it can be switched over cyclically and in which it frees none, one or more of the separate, parallel-flow fluid-outlet channels 42.

An axial movement of the actuating element 46 in the direction of the rear side 43 of the valve gives rise, by means of an advancing mechanism which is known per se, to the valve closure body 45 being raised up axially from its valve seat 47 and being rotated through a defined angle from one discrete stable rotary position into the next. It is thus possible for a fluid supplied by the fluid-inlet channel 41 to be fed optionally into the various fluid-outlet channels 42. Moreover, the valve closure body 45 can be moved into a maximum-throughflow position or parked position, in which it has been raised up from the valve seat 47 and all of the fluid-exit channels 42 are freed.

The jet disc unit 30 forms the termination on the fluid-exit side of the spray head 1. As can be gathered from FIG. 1, it has a plurality of jet-exit openings 35a, 35b, 35c, 35d distributed over its exit surface 34. A first group of the jet-exit openings 35a is located in a central region of the exit surface 34, a second group of the jet-exit openings 35b is located in a first middle annular region of the exit surface 34, said annular region adjoining the central region radially, a third group of the jet-exit openings 35c is located in a second middle annular region of the exit surface 34, said annular region adjoining the first middle annular region radially, and a fourth, remaining group of the jet-exit openings 35d is located in an outer annular region of the exit surface 34. The various groups of jet-exit openings 35a, 35b, 35c, 36d can be designed for achieving different spray-jet characteristics, e.g. a perlator, a massage jet, a surge jet and a normal jet. The separate fluid-exit channels 42 of the valve 40 are each fluidically connected to separate exit chambers 36a, 36b, 36c, 36d, which are formed on the rear side 37 of the jet disc unit 30 and from which in each case an associated group of the jet-exit openings 35a, 35b, 35c, 35d run out. It is thus possible, by virtue of the valve 40 being switched, to select different jet-exit patterns of a shower jet. If the valve closure body 45 is moved into the maximum-throughflow position, the shower water can flow through all of the jet-exit openings 35a, 35b, 35c, 35d at the same time. A plurality of seals are inserted into the spray head 1 in order to seal the water channelling therein.

For the purpose of operating the switchover and shut-off valve 40, the valve operating element 50 is arranged in the form of a rotary adjuster on a peripheral side 7 of the spray head housing 2, wherein the peripheral side 7 of the spray head housing 2 is different from a front side 6, which is defined by the jet disc unit 30, and is directed towards the actuating element 46 of the valve 40. The rotary adjuster 50 has a rotary knob protruding all the way out of the spray head housing 2. This configuration allows a user to grip and rotate the rotary adjuster easily, e.g. even if his hand is soapy.

FIG. 2 shows more precisely a transmission means or a transmission mechanism, which transforms a rotary movement of the rotary adjuster 50 about a longitudinal operating element axis 51 into an axial movement of the actuating element 46 along the longitudinal valve axis 44. A transmission arm 60 in the form of a leaf spring has one end 61 pushed into, and fixed in, an accommodating slot 38 on the rear side 37 of the jet disc unit 30. The transmission arm 60 is coupled to the valve operating element 50 at a first coupling point 62, which is spaced apart from the fixed end 61, and is coupled to the actuating element 46 at a second coupling point 63, which is spaced apart from the fixed end 61.

The transmission arm 60 has, at its free end 65, a sleeve 64, which engages around an axial end region of the valve operating element 50. The sleeve 64 accommodates a slanted surface coupling 55, which transforms a rotary movement of the valve operating element 50 about the longitudinal operating element axis 51 into an axial movement of the actuating element along the longitudinal valve axis 44. For this purpose, a first slanted surface element 56 is provided at the axial end of the valve operating element 50. A second slanted surface element 57 is provided on the inner side of the sleeve 64 of the transmission arm 60. If the rotary adjuster 50 is rotated in any desired direction about the longitudinal operating element axis from its initial position, which is shown in FIG. 2 and in which the valve closure body 45 is located in a certain discrete stable rotary position, the two slanted surface elements 56, 57 slide on one another over a corresponding angle range. As a result, the free end 65 of the transmission arm 60 moves axially away from the rotary adjuster 50, along the longitudinal operating element axis 51, and the transmission arm 60 pivots about its fixed end 61. The sleeve 64 here is still in engagement around the slanted surface element 56, and this means that a fail-safe coupling is maintained between the rotary adjuster 50 and the transmission arm 60.

The transmission arm 60 has a tapered cross section in the region directly adjoining its fixed end 61, this making it easier for the transmission arm to bend. The transmission arm 60, at the second coupling point 63, runs virtually perpendicularly to the longitudinal valve axis 44, whereby the movement of the transmission arm 60 pivoting onto the valve 40 is transformed very efficiently into an axial movement of the actuating element 46 along the longitudinal valve axis 44. As a result, the advancing mechanism of the valve 40 is triggered and the valve closure body 45 is raised up from the valve seat 47 and rotated. Since the second coupling point 63 is arranged between the first coupling point 62 and the fixed end 61 of the transmission arm 60, a lever action means that a force which has to be applied to the valve operating element 50 in order to actuate the valve 40 is kept to a relatively low level.

Once the advancing device has been triggered, a user can let go of the rotary adjuster 50. If the rotary adjuster 50 has been rotated to the extent where a peak region of the slanted surface element 56 has rotated beyond a peak region of the slanted surface element 57, then the rotary adjuster 50 is rotated onwards into a position corresponding to its initial position. Otherwise, it rotates back into its previous initial position. This takes place on account of the restoring spring force of the transmission arm 60, designed in the form of a leaf spring, in combination with the slanted surface coupling 55. The valve closure body 45 is forced, by a valve spring 48, in the direction of the valve seat 47 and thus pushes the actuating element 46 back out of the valve 40 in the direction of the transmission arm 60.

At least one of the two slanted surface elements 56, 57 may have a flattening or indent in its peak region, and therefore the peak of the one slanted surface element remains in a stable manner in the indent of the other slanted surface element or the two slanted surface elements 56, 57 rest against one another in a stable manner by way of their flattened peak regions. This can then realize a sustained operating position. In this sustained operating position, the axially moveable valve closure body 45 is located in its maximum-throughflow position, in which all of the fluid-exit channels 42 are freed.

The mounting of the rotary adjuster 50 on the spray head housing 2 can be seen more precisely in FIG. 3. A mounting element 80 is inserted into an opening 8 on the peripheral side 7 of the spray head housing 2 and has a collar 81 resting against the peripheral side 7 of the spray head housing 2 from the outside. The mounting element 80 is prevented from passing out of the spray head housing 2 by a snap-fit ring 82, which is supported internally on the peripheral side 7. The rotary adjuster 50 is secured axially by radial protrusions 52, 53. During assembly of the spray head 1, the rotary adjuster 50 can be the last part to be installed, by being pushed into the opening 8.

FIG. 4 shows a detail-specific view corresponding to FIG. 2, this time relating to a variant of the spray head 1 in which an additional restoring spring 90 is arranged between the free end 65 of the transmission arm 60, which is clamped in at one end, and a spring holder 49 on the switchover and shut-off valve 40. In addition to the spring force of the transmission arm 60, designed in the form of a leaf spring, the restoring spring 90 subjects the transmission arm 60 and thus the valve operating element 50, via the slanted surface coupling 55, to a restoring force.

FIG. 5 shows an alternative embodiment of a spray head 1′, wherein, to ease understanding, the text here and hereinbelow indicates identical and functionally equivalent elements using the same reference signs as were used for the embodiment of FIGS. 1 to 4, to the description of which reference can be made in this respect. The spray head 1′ of FIG. 5 differs from the embodiment of FIGS. 1 to 4 in that a transmission arm 60′ is formed in one piece with a rear side 37′ of a jet disc unit 30′. In FIG. 5, the rotary adjuster 50 is located in the aforementioned sustained operating position, which has been rotated through 90° in relation to the initial position and in which the actuating element 46 has been pushed axially along the longitudinal valve axis 44 in the direction of the rear side 43 of the valve. This means that the valve closure body 45 is retained in the maximum-throughflow position, in which it has been raised up from the valve seat 47 and frees all of the fluid-outlet channels 42.

FIG. 6 shows a further exemplary embodiment of a spray head 1″ according to the invention, wherein identical and functionally equivalent elements, once again, are provided with the same reference signs. The example of FIG. 6 differs from the preceding examples of FIGS. 1 to 5 in that a transmission arm 60″, rather than being retained on a rear side 37″ of a jet disc unit 30″, has a fixed end 61″ clamped in on a basic spray head body 10″ and extends downwards from there in FIG. 6. It is also the case that a sleeve 64″ and slanted surface elements 56″, 57″ have been modified. Moreover, a first coupling point 62″, at which the transmission arm 60″ and the valve operating element 50 are coupled, is located between the fixed end 61″ and a second coupling point 63″, at which the transmission arm 60″ of the actuating element 46 of the valve 40 are coupled.

In all of the examples shown, the slanted surface elements of the slanted surface coupling are of essentially the same shape in the region in which the slanted surface elements slide on one another. Other shapes (not shown) of a slanted surface coupling are possible as an alternative. In appropriate embodiments, the sustained operating position is not present. In particular it is then possible for the valve to be configured such that, when the valve is switched, the valve closure body merely rotates and is not raised up from a valve seat. Moreover, the valve operating element is designed in a form of a rotary adjuster in all of the examples shown. As an alternative, it is also possible for the valve operating element used to be in the form, for example, of a pushbutton. The slanted surface coupling can then be dispensed with. Furthermore, instead of the clamped-in spring strip, the transmission arm used may be in the form of a rotatably mounted, rigid strip. It is possible here for example for a helical spring, integrated in a rotary-mounted means, or, as shown in the variant of FIG. 4, an additional restoring spring to subject the rigid strip to a restoring force. In alternative embodiments, the transmission arm is dispensed with and the transmission means contain, for example, a slanted surface coupling, by means of which a rotary and/or axial movement of the valve operating element is transformed into an axial movement of the actuating element. In all of the examples shown, the sleeve, which is formed in one piece with the transmission arm, engages around the one end of the valve operating element. It is additionally possible, in appropriate embodiments, for a further sleeve, fastened on the transmission arm, to engage around one end of the actuating element of the valve.

As is clear from the exemplary embodiments shown and explained above, the invention provides an advantageous spray head which is easy to use, as far as valve actuation is concerned, and allows a high level of design flexibility and can be used, for example, for an overhead or hand-held spray of a shower system.

What is claimed is:

1. A spray head comprising
a spray head housing
a valve disposed within the spray head housing including an actuating element, the actuating element being axially movable along a valve longitudinal axis,
a valve operating element controllable by a user and arranged on the spray head housing being at least one of rotatable around and axially movable along an operating element longitudinal axis, and
a transmission to transmit at least one of a rotary and axial movement of the valve operating element into an axial movement of the actuating element,
wherein the valve operating element is arranged with the operating element longitudinal axis one of non-parallel to an parallel offset to the valve longitudinal axis.

2. The spray head according to claim 1, wherein the valve longitudinal axis is arranged non-parallel to a jet disk longitudinal axis of a jet disk unit arranged in the spray head housing on a front side.

3. The spray head according to claim 1, wherein the transmission includes a slanted surface coupling, that transmits the rotary movement of the valve operating element around the operating element longitudinal axis into the axial movement of the actuating element along the valve longitudinal axis.

4. The spray head according to claim 1, wherein the transmission includes a transmission arm one of securely and rotatably movably retained on a fixed end, which transmission arm is coupled to the valve operating element on at a first coupling location spaced from the fixed end and coupled to the actuating element at a second coupling locations spaced from the fixed end.

5. The spray head according to claim 4, wherein the second coupling location is disposed between the first coupling location and the fixed end of the transmission arm.

6. The spray head according to claim 4, wherein the fixed end is retained on a jet disk rear side of a jet disk unit arranged in the spray head housing on a front side.

7. The spray head according to claim 4, wherein the transmission arm has at least one of a first sleeve by which the transmission arm is coupled to the valve operating element and a second sleeve by which the transmission arm is coupled to the actuating element.

8. The spray head according to claim 3, wherein the slanted surface coupling is accommodated in a first sleeve by which the transmission arm is coupled to the valve operating element.

9. The spray head according to claim 1, wherein the valve operating element is movable between an initial position, in which initial position a valve closure body rests against a valve seat, and a operating position, wherein the valve operating element returns automatically from the operating position to the initial position.

10. The spray head according to claim 1, wherein the valve operating element is a rotary adjuster disposed on a peripheral side of the spray head housing and protrudes from the spray head housing.

11. The spray head according to claim 1, wherein the valve operating element is movable between an initial position at which a valve closure body rests against a valve seat and a operating position that is implemented as a sustained operating position in which the valve closure body is lifted from the valve seat.
